(19) United States
(12) Patent Application Publication
(10) Pub. No.: US 2009/0093391 A1
(43) Pub. Date: Apr. 9, 2009

(54) LIQUID WASHING COMPOSITIONS AND LIQUID CLEANING COMPOSITIONS

(75) Inventors: Thomas Klein, Heidelberg (DE); Wolfgang Wambach, Koln (DE); Ralf-Johann Moritz, Neuss (DE)

Correspondence Address: LANXESS CORPORATION, 111 RIDC PARK WEST DRIVE, PITTSBURGH, PA, 15275-1112, US

(73) Assignee: LANXESS Deutschland GmbH, Leverkusen (DE)

(21) Appl. No.: 12/234,148

(22) Filed: Sep. 19, 2008

(30) Foreign Application Priority Data
Oct. 4, 2007 (DE) 102007047433.6

(51) Int. Cl. C11D 7/42

(52) U.S. Cl. 510/221; 510/393; 510/321

(57) ABSTRACT

The present invention relates to substance mixtures comprising at least one complexing agent and at least one enzyme, and to the use thereof in liquid washing compositions and liquid cleaning compositions, said complexing agent having a complex formation constant for calcium of from 3 to 6 and said calcium-binding enzyme having a calcium binding capacity of at least 1 molar equivalent of calcium per molar equivalent of enzyme.

The present invention relates to substance mixtures based on at least one complexing agent and at least one enzyme, and to the use thereof in liquid washing compositions and liquid cleaning compositions, said complexing agent having a complex formation constant for calcium of from 3 to 6 and said calcium-binding enzyme having a calcium binding capacity of at least 1 molar equivalent of calcium per molar equivalent of enzyme.

### BACKGROUND OF THE INVENTION

In washing and cleaning compositions, various complexing agents are used to bind the hardness formers in water, especially calcium and magnesium ions, in order to prevent the formation of insoluble salts (deposits) and soaps (lime soaps). Known representatives of so-called organic builder substances are ethylenediamine-N,N′-disuccinate (EDDS), iminodisuccinate (IDS), hydroxyiminodisuccinate (HIDS), glyceryl disuccinates, glyceryl trisuccinates, ethylenediaminetetraacetic acid (EDTA) or methylglycinediacetic acid (MGDA), derivatives thereof or salts thereof with alkali metals, preferably with sodium and/or potassium. These complexing agents form what are known as chelates with the hardness formers of water and in this way prevent the undesired formation of deposits and soaps.

For example, the combination of complexing agents, preferably of IDS, with enzymes in liquid washing compositions is known from US 2002/0004475 A1. WO 2005 052 108 A1 discloses a mixture of tetrasodium iminodisuccinate and enzyme in a nonaqueous carrier component, an oil or a gel. US 2007/0129277 A1 also discloses a dishwasher detergent formulation based on IDS, enzyme and a nonaqueous carrier component, a mineral oil.

A disadvantage of the liquid washing compositions which are based on IDS and enzyme and are described in the prior art is their inadequate storage stability when they are formulated as a liquid washing composition or liquid detergent. Specifically influences of temperature and protolysis or autolysis, however, complicate the use of IDS and enzymes in liquid washing compositions and liquid detergents.

It was therefore an object of the present invention to provide complexing agent-based, enzyme-containing liquid washing compositions or liquid detergents which, on the one hand, withstand thermal influences, protolysis or autolysis even in the course of prolonged storage, but, on the other hand, satisfy the requirements on modern washing and cleaning compositions, specifically the display of their full washing or cleaning activity at low washing or cleaning temperatures.

### SUMMARY OF THE INVENTION

The solution and hence the subject matter of the present invention is a substance mixture which comprises a combination of at least one complexing agent having a complex formation constant for calcium of from 3 to 6, preferably from 3.1 to 5.9, more preferably from 3.5 to 5.2, with at least one calcium-binding enzyme with a calcium binding capacity of at least 1 molar equivalent of calcium per molar equivalent of enzyme, preferably from 1 to 5 molar equivalents of calcium per molar equivalent of enzyme, more preferably from 1 to 3 molar equivalents of calcium per molar equivalent of enzyme. In a preferred embodiment, the substance mixture consists of the two components complexing agent and calcium-binding enzyme having a calcium binding capacity of at least 1 molar equivalent of calcium per molar equivalent of enzyme.

For clarification, it should be stated that the scope of the invention encompasses all definitions and parameters recited below, in general or within preferred ranges, in any desired combinations.

Complexing agents preferred in accordance with the invention are IDS, HEIDA (N-(2-hydroxyethyliminodiacetic acid) disodium salt) and/or EDDS, derivatives thereof and/or salts thereof with alkali metals. Particular preference is given in accordance with the invention to using IDS, derivatives thereof or salts thereof with alkali metals, especially potassium or sodium. However, particular preference is also given in accordance with the invention to using HEIDA.

Preferably in accordance with the invention, the substance mixture comprising complexing agent and calcium-binding enzyme formulated in liquid washing compositions or liquid cleaning compositions is used in cleaning solutions or wash liquors at temperatures of from 10 to 65° C., more preferably from 15 to 40° C., especially preferably from 20 to 30° C. The aqueous cleaning solutions or wash liquors preferably have a pH of from 6 to 14, more preferably a pH of from 7 to 13, especially preferably a pH of from 8 to 10.

Preferred calcium-binding enzymes in the context of the present invention with the calcium binding capacity defined above are lipases, cellulases, proteases or alpha-amylases.

Lipases particularly preferred in accordance with the invention stem from Humicola or Pseudomonas, especially preferably from Humicola lanuginosa (EP-A 0 258 068), Humicola insolens (WO 96/13580), Pseudomonas alcaligenes, Pseudomonas pseudoalcaligens (EP-A 0 218 272), Pseudomonas cepacia (EP-A 0 331 376), Pseudomonas stutzeri (GB 1,372,034), Pseudomonas fluorescens, Pseudomonas sp strain SD 705 (WO 95/06720 and WO 96/27002) or Pseudomonas wisconsinensis (WO 96/12012). Very especially preferred in accordance with the invention are lipases which are obtainable from Humicola lanuginosa and have been developed with amino acid exchange D 96 h, especially those obtainable under the trade name Lipex® (here Lipex® 100) or Lumafast®.

Proteases particularly preferred in accordance with the invention are alkaline, microbial proteases or trypsin-like proteases, most preferably from Bacillus subtilisin Novo, Bacillus subtilisin Carlsberg, Bacillus subtilisin 309, Bacillus. subtilisin 147, Bacillus. subtilisin 168 (WO 89/06279), Fusarium proteases (WO 89/06270 and WO 94/25583), more preferably variants from WO 92/19729, WO 98/20115, WO 98/20116 or WO 98/34946, especially preferably with substitutions in the 27, 36, 57, 68, 76, 87, 97, 101, 104, 106, 120, 123, 167, 170, 194, 206, 218, 222, 224, 235, 245, 252 and 274 positions, very especially preferably those under the trade name Polarzyme® (here Polarzyme® 12), Purafect® or Properase®.

Alpha-amylases particularly preferred in accordance with the invention stem from Bacillus licheniformis (GB 1,296,839), most preferably from variants with substitutions in one or more of positions 15, 23, 105, 106, 124, 128, 133, 154, 156, 181, 188, 190, 197, 202, 208, 209, 243, 264, 304, 305, 391, 408 and 444. Very especially preferably, those under the trade name Stainzyme® (here Stainzyme®12) or Purastar®.

Cellulases particularly preferred in accordance with the invention stem from Bacillus, Pseudomonas, Humicola, Fusarium, Thielavia, Acremonium, most preferably from Humicola insolens, Myceliophthora thermophila, Fusarium oxysporum (U.S. Pat. No. 4,435,307; U.S. Pat. No. 5,648,263; U.S. Pat. No. 5,691,178; U.S. Pat. No. 5,776,757; WO 89/09259). Very especially preferred are variants from EP 0 495 257, EP 0 531 372, WO 96/11262, WO 96/29397, WO 98/08940, WO 94/07998, EP 0 531 315, U.S. Pat. No. 5,457,046, U.S. Pat. No. 5,686,593, U.S. Pat. No. 5,763,254, WO 95/24471, WO 98/12307 and PCT/DK98/00299; very especially preferably, those under the trade name Celluzyme® (here Celluzyme®0.7), Genencor detergent cellulase L or IndiAge® Neutra are used.

Surprisingly, a substance mixture comprising at least one complexing agent having a complex formation constant for calcium of from 3 to 6 and at least one calcium-binding enzyme having a calcium binding capacity of at least 1 molar equivalent of calcium per molar equivalent of enzyme exhibits outstanding cleaning performances when employed in detergents or washing compositions, even at low wash temperatures, and allows storage of corresponding cleaning formulations in liquid form over a prolonged period without activity losses of the enzymes brought about by thermal influences, proteolysis or autolysis. Low temperatures in the context of the present invention are the above-defined temperatures typically employed in washing and cleaning operations.

The problem of storage stability to be addressed in accordance with the invention relates to liquid washing compositions or liquid cleaning compositions which are stored under standard pressure within a temperature range from 0 to 50° C., preferably from 10 to 35° C., over a period of up to 90 days, preferably from 70 to 90 days, and themselves have a pH of 7.5-10, preferably 8-9.

However, the invention also relates to liquid washing formulations or liquid cleaning formulations which comprise such a substance mixture comprising at least one complexing agent having a complex formation constant for calcium of from 3 to 6 with at least one calcium-binding enzyme having a calcium binding capacity of at least 1 molar equivalent of calcium per molar equivalent of enzyme from one of the abovementioned enzyme classes.

Particular preference is given in accordance with the invention to liquid washing or cleaning formulations which comprise such a substance mixture comprising at least one complexing agent having a complex formation constant for calcium of from 3 to 6 with at least three calcium-binding enzymes each having a calcium binding capacity of at least 1 molar equivalent of calcium per molar equivalent of enzyme from in each case one of the abovementioned enzyme classes.

Very particular preference is given in accordance with the invention to washing and cleaning formulations which comprise such a substance mixture comprising at least one complexing agent having a complex formation constant for calcium of from 3 to 6 and four calcium-binding enzymes each having a calcium binding capacity of at least 1 molar equivalent of calcium per molar equivalent of enzyme from in each case one of the four abovementioned enzyme classes.

Very especially preferred are substance mixtures comprising the combination of at least one complexing agent from the group of IDS, HEIDA or EDDS with the calcium-binding enzymes Lipex® 100, Stainzyme® 12, Polarzyme® 12 and Celluzyme® 0.7 obtainable from Novozymes A/S, or the abovementioned enzymes from Genencor. Very especially preferred in accordance with the invention are substance mixtures comprising the combination of IDS with one or more of the aforementioned calcium-binding enzymes. Even more especially preferred in accordance with the invention are also substance mixtures comprising the combination of HEIDA with one or more of the aforementioned calcium-binding enzymes or the abovementioned enzymes from Genencor. Correspondingly preferred are inventive liquid washing or cleaning compositions which comprise the inventive substance mixtures based on the L variants of the abovementioned calcium-binding enzymes obtainable from Novozymes A/S.

In the liquid washing compositions or liquid cleaning compositions, the complexing agents having a complex formation constant for calcium of from 3 to 6 are present preferably to an extent of from 0.01 to 25% by weight, more preferably to an extent of from 1 to 10% by weight. In addition to this complexing agent with a complex formation constant for calcium of from 3 to 6, it is, though, quite possible for further complexing agents also to be used in the liquid washing compositions or liquid cleaning compositions.

In the liquid washing compositions or liquid cleaning compositions, the proportion of enzymes to be used having a calcium binding capacity of at least 1 molar equivalent of calcium per molar equivalent of enzyme is preferably from 0.1 to 5% by weight, more preferably from 0.11 to 2.5% by weight.

Inventive liquid washing compositions or liquid cleaning compositions comprise, in a preferred embodiment, as well as the substance mixture of at least one complexing agent having a complex formation constant for calcium of from 3 to 6 and calcium-binding enzyme having a calcium binding capacity of at least 1 molar equivalent of calcium per molar equivalent of enzyme, water in amounts—based on the overall composition—of preferably up to about 85% by weight and especially from 40% by weight to 75% by weight, which may, if desired, also be exchanged partly for a water-soluble solvent component. Nonaqueous solvents which can be used in the liquid compositions stem, for example, from the group of mono- or polyhydric alcohols, alkanolamines or glycol ethers, provided that they are miscible with water in the concentration range stated. The solvents are preferably selected from ethanol, n- or i-propanol, the butanols, ethylene glycol, butanediol, glycerol, diethylene glycol, butyldiglycol, hexylene glycol, ethylene glycol methyl ether, ethylene glycol ethyl ether, ethylene glycol propyl ether, ethylene glycol monobutyl ether, diethylene glycol methyl ether, diethylene glycol ethyl ether, propylene glycol methyl, ethyl or propyl ether, dipropylene glycol monomethyl or monoethyl ether, diisopropylene glycol monomethyl or monoethyl ether, methoxy-, ethoxy- or butoxytriglycol, 1-butoxyethoxy-2-propanol, 3-methyl-3-methoxybutanol, propylene glycol t-butyl ether and mixtures thereof. The amount of the nonaqueous water-soluble solvent component based on the total amount of the washing and cleaning composition is preferably up to 15% by weight, especially from 0.5% by weight to 10% by weight.

In a further preferred embodiment, the liquid washing compositions and liquid cleaning compositions may additionally comprise surfactant, in which case anionic, nonionic, cationic and/or amphoteric surfactants can be used. Preference is given to the presence of anionic surfactants, mixtures of anionic and nonionic surfactants being particularly advantageous from a performance point of view. The total surfactant content of the liquid composition is preferably in the range from 10% by weight to 60% by weight, especially from 15% by weight to 50% by weight, based in each case on the overall liquid composition.

The nonionic surfactants used are preferably alcohol alkoxylates, i.e. alkoxylated alcohols, advantageously ethoxylated alcohols, especially primary alcohols having preferably from 8 to 18 carbon atoms and an average of from 1 to 12 mol of ethylene oxide (EO) per mole of alcohol, in which the alcohol radical may be linear or preferably 2-methyl-branched, or may contain linear and methyl-branched radicals in a mixture, as are typically present in oxoalcohol radicals. In particular, however, alcohol ethoxylates with linear radicals from alcohols of native origin having from 12 to 18 carbon atoms, for example from coconut alcohol, palm alcohol, tallow fat alcohol or oleyl alcohol, and an average of from 2 to 8 EO per mole of alcohol, are preferred. The preferred ethoxylated alcohols include, for example, C12-14-alcohols with 3 EO, 4 EO or 7 EO, C9-11-alcohol with 7 EO, C13-15-alcohols with 3 EO, 5 EO, 7 EO or 8 EO, C12-18-alcohols with 3 EO, 5 EO or 7 EO and mixtures thereof, such as mixtures of C12-14-alcohol with 3 EO and C12-C18-alcohol with 7 EO. The degrees of ethoxylation reported are statistical averages which may be an integer or a fraction for a specific product. Preferred alcohol ethoxylates have a narrowed homolog distribution (narrow range ethoxylates, NRE). In addition to these nonionic surfactants, it is also possible to use fatty alcohols with more than 12 EO units. Examples thereof are tallow fat alcohol with 14 EO, 25 EO, 30 EO or 40 EO. It is also possible in accordance with the invention to use nonionic surfactants which contain EO and PO groups together in the molecule. In this case, it is possible to use block copolymers with EO-PO block units or PO-EO block units, but also EO-PO-EO copolymers or PO-EO-PO copolymers. It is also possible to use mixed alkoxylated nonionic surfactants in which EO and PO units are not distributed blockwise but rather randomly. Such products are obtainable by the simultaneous action of ethylene oxide and propylene oxide on fatty alcohols.

In addition, the nonionic surfactants used may also be alkylglycosides, especially of the general formula RO(G)x in which R is a primary straight-chain or methyl-branched, especially 2-methyl-branched, aliphatic radical having from 8 to 22 and preferably from 12 to 18 carbon atoms, and G is the symbol which represents a glycose unit having 5 or 6 carbon atoms, preferably glucose. The degree of oligomerization x, which states the distribution of monoglycosides and oligoglycosides, is any number between 1 and 10; x is preferably from 1.2 to 1.4.

A further class of nonionic surfactants for use with preference, which are used either as the sole nonionic surfactant or in combination with other nonionic surfactants, is that of alkoxylated, preferably ethoxylated or ethoxylated and propoxylated, fatty acid alkyl esters, preferably having from 1 to 4 carbon atoms in the alkyl chain, especially fatty acid methyl esters.

Nonionic surfactants of the amine oxide type, for example N-cocoalkyl-N,N-dimethylamine oxide and N-tallowalkyl-N,N-dihydroxyethylamine oxide, and of the fatty acid alkanolamide type may also be suitable. The amount of these nonionic surfactants is preferably not more than that of the alcohol alkoxylates, especially not more than half thereof.

Further suitable nonionic surfactants are polyhydroxy fatty acid amides of the formula (I),

R—CO—NR1-[Z] (I)

in which RCO is an aliphatic acyl radical having from 6 to 22 carbon atoms, R1 is hydrogen, an alkyl or hydroxyalkyl radical having from 1 to 4 carbon atoms, and [Z] is a linear or branched polyhydroxyalkyl radical having from 3 to 10 carbon atoms and from 3 to 10 hydroxyl groups. The polyhydroxy fatty acid amides are known substances which can typically be obtained by reductive amination of a reducing sugar with ammonia, an alkylamine or an alkanolamine and subsequent acylation with a fatty acid, a fatty acid alkyl ester or a fatty acid chloride. The group of polyhydroxy fatty acid amides also includes compounds of the formula (II),

R—CO—N(—R1-O—R2)-[Z] (II)

in which R is a linear or branched alkyl or alkenyl radical having from 7 to 12 carbon atoms, R1 is a linear, branched or cyclic alkyl radical or an aryl radical having from 2 to 8 carbon atoms, and R2 is a linear, branched or cyclic alkyl radical or an aryl radical or an oxyalkyl radical having from 1 to 8 carbon atoms, preference being given to C1-C4-alkyl or phenyl radicals, and [Z] is a linear polyhydroxyalkyl radical whose alkyl chain has been substituted by at least two hydroxyl groups, or alkoxylated, preferably ethoxylated or propoxylated, derivatives of this radical. [Z] is preferably obtained by reductive amination of a sugar, for example glucose, fructose, maltose, lactose, galactose, mannose or xylose. The N-alkoxy- or N-aryloxy-substituted compounds can then be converted by reaction with fatty acid methyl esters in the presence of an alkoxide as a catalyst to the desired polyhydroxy fatty acid amides.

The content of nonionic surfactants in the liquid washing compositions and cleaning compositions is preferably from 5% by weight to 30% by weight, especially from 7% by weight to 20% by weight and more preferably from 9% by weight to 15% by weight, based in each case on the overall composition. In a preferred embodiment, the nonionic surfactant is selected from alcohol alkoxylate and alkylpolyglycoside and mixtures thereof.

The anionic surfactants used may, for example, be those of the sulfonate and sulfate type. Useful surfactants of the sulfonate type preferably include C9-C13-alkylbenzenesulfonates, olefinsulfonates, i.e. mixtures of alkene- and hydroxyalkanesulfonates, and also disulfonates, as obtained, for example, from C12-C18-monoolefins with a terminal or internal double bond by sulfonation with gaseous sulfur trioxide and then alkaline or acidic hydrolysis of the sulfonation products. Also suitable are alkanesulfonates which are obtained from C12-C18-alkanes, for example by sulfochlorination or sulfoxidation with subsequent hydrolysis or neutralization. Equally suitable are also esters of α-sulfo fatty acids (ester sulfonates), for example the α-sulfonated methyl esters of the hydrogenated coconut fatty acids, palm kernel fatty acids or tallow fatty acids.

Further suitable anionic surfactants are sulfated fatty acid glyceryl esters. Fatty acid glyceryl esters are understood to mean the mono-, di- and triesters and mixtures thereof, as obtained in the preparation by esterification of a monoglycerol with from 1 to 3 mol of fatty acid or in the transesterification of triglycerides with from 0.3 to 2 mol of glycerol. Preferred sulfated fatty acid glyceryl esters are the sulfonation products of saturated fatty acids having from 6 to 22 carbon atoms, for example of caproic acid, caprylic acid, capric acid, myristic acid, lauric acid, palmitic acid, stearic acid or behenic acid.

Preferred alk(en)yl sulfates are the alkali metal salts and especially the sodium salts of the sulfuric monoesters of the C12-C18 fatty alcohols, for example from coconut fat alcohol, tallow fat alcohol, lauryl alcohol, myristyl alcohol, cetyl alcohol or stearyl alcohol, or of the C10-C20 oxo alcohols and those monoesters of secondary alcohols of these chain lengths. Also preferred are alk(en)yl sulfates of the chain length mentioned which contain a synthetic straight-chain alkyl radical prepared on a petrochemical basis, which have analogous degradation behavior to the equivalent compounds based on oleochemical raw materials. From a washing point of view, preference is given to the C12-C16-alkyl sulfates and C12-C15-alkyl sulfates, and also C14-C15-alkyl sulfates. 2,3-Alkyl sulfates, which can be obtained, for example, as commercial products from the Shell Oil Company under the name DAN®, are also suitable anionic surfactants.

The sulfuric monoesters of the abovementioned alcohol alkoxylates, for example of the straight-chain or branched C7-C21-alcohols ethoxylated with from 1 to 6 mol of ethylene oxide, such as 2-methyl-branched C9-C11-alcohols with an average of 3.5 mol of ethylene oxide (EO) or C12-C18-fatty alcohols with from 1 to 4 EO, are also suitable. These are often also referred to as ether sulfates.

Further suitable anionic surfactants are also the salts of alkylsulfosuccinic acid, which are also referred to as sulfosuccinates or as sulfosuccinic esters and are the monoesters and/or diesters of sulfosuccinic acid with alcohols, preferably fatty alcohols and especially ethoxylated fatty alcohols. Preferred sulfosuccinates contain C8-C18 fatty alcohol radicals or mixtures thereof. Especially preferred sulfosuccinates contain a fatty alcohol radical which derives from ethoxylated fatty alcohols which, considered alone, are nonionic surfactants (see below for description). Particular preference is given in turn to sulfosuccinates whose fatty alcohol radicals derive from ethoxylated fatty alcohols with a narrow homolog distribution. Equally, it is also possible to use alk(en)ylsuccinic acid having preferably from 8 to 18 carbon atoms in the alk(en)yl chain or salts thereof.

Preferred anionic surfactants are soaps. Suitable soaps are saturated and unsaturated fatty acid soaps, such as the salts of lauric acid, myristic acid, palmitic acid, stearic acid, (hydrogenated) erucic acid and behenic acid, and also soap mixtures derived especially from natural fatty acids, for example coconut fatty acids, palm kernel fatty acids, olive oil fatty acids or tallow fatty acids. In a preferred embodiment, the washing composition contains from 2% by weight to 20% by weight, especially from 3% by weight to 15% by weight and more preferably from 5% by weight to 10% by weight of fatty acid soap. Fatty acid soaps are an important constituent for the washing power of a liquid, especially aqueous, washing and cleaning compositions. It has been found that, surprisingly, when the low-methylation carboxymethylcellulose ether is used, clear and stable liquid washing compositions are obtained even in the presence of high amounts of fatty acid soap. Typically, the use of high amounts (=2% by weight) of fatty acid soap in such systems leads to cloudy and/or unstable products.

The anionic surfactants, including the soaps, may be present in the form of their sodium, potassium or ammonium salts, and as soluble salts of organic bases, such as mono-, di- or triethanolamine. The anionic surfactants are preferably present in the form of their sodium or potassium salts, especially in the form of their sodium salts.

The content in preferred liquid washing or cleaning compositions of anionic surfactants is from 5% by weight to 35% by weight, especially from 8% by weight to 30% by weight and more preferably from 10% by weight to 25% by weight, based in each case on the overall composition. It is particularly preferred that the amount of fatty acid soap is at least 2% by weight, more preferably at least 3% by weight and especially from 4% by weight to 10% by weight. In a further preferred embodiment, the composition comprises at least 2, especially 3, different anionic surfactants selected from alkylbenzenesulfonate, ether sulfate and fatty acid soap.

In a further preferred embodiment, an inventive liquid washing composition or liquid cleaning composition may comprise a polyacrylate which acts as a cobuilder or a polyaspartic acid and optionally also polyacrylate which acts as a thickener. The polyacrylates include polyacrylate or polymethacrylate thickeners, for example the high molecular weight homopolymers of acrylic acid crosslinked with a polyalkenyl polyether, especially an allyl ether of sucrose, pentaerythritol or propylene (INCI name according to “International Dictionary of Cosmetic Ingredients” of the “The Cosmetic, Toiletry and Fragrance Association (CTFA)”: Carbomer), which are also referred to as carboxyvinylpolymers. Such polyacrylic acids are obtainable, inter alia, from 3V Sigma under the trade name Polygel®, e.g. Polygel DA, and from Noveon under the trade name Carbopol®, e.g. Carbopol 940 (molecular weight approx. 4 000 000), Carbopol 941 (molecular weight approx. 1 250 000) or Carbopol 934 (molecular weight approx. 3 000 000). They also include the following acylic acid copolymers: (i) copolymers of two or more monomers from the group of acrylic acid, methacrylic acid and their monoesters preferably formed with C1-C4-alkanols (INCI Acrylates Copolymer), which include, for instance, the copolymers of methacrylic acid, butyl acrylate and methyl methacrylate (CAS number according to Chemical Abstracts Service: 25035-69-2), or of butyl acrylate and methyl methacrylate (CAS 25852-37-3), and which are obtainable, for example, from Rohm & Haas under the trade names Aculyn® and Acusol®, and from Degussa (Goldschmidt) under the trade name Tego® Polymer, for example the anionic nonassociative polymers Aculyn 22, Aculyn 28, Aculyn 33 (crosslinked), Acusol 810, Acusol 823 and Acusol 830 (CAS 25852-37-3); (ii) crosslinked high molecular weight acrylic acid copolymers, which include, for instance, the copolymers of C10-C30-alkyl acrylates with one or more monomers from the group of acrylic acid, methacrylic acid and their monoesters formed preferably with C1-C4-alkanols, said copolymers having been crosslinked with an allyl ether of sucrose or of pentaerythritol (INCI Acrylates/C10-C30 Alkyl Acrylate Crosspolymer), and which are obtainable, for example, from Noveon under the trade name Carbopol®, e.g. the hydrophobized Carbopol ETD 2623 and Carbopol 1382 (INCI Acrylates/C10-C30 Alkyl Acrylate Crosspolymer) and Carbopol Aqua 30 (formerly Carbopol EX 473). Preferred liquid washing compositions comprise the polyacrylate or polyaspartic acid in an amount up to 5% by weight, especially from 0.1% by weight to 2.5% by weight. It is advantageous when the polyacrylate is a copolymer of an unsaturated mono- or dicarboxylic acid and of one or more C1-C30-alkyl esters of (meth)acrylic acid.

The viscosity of the inventive liquid washing and cleaning compositions can be measured by customary standard methods (for example Brookfield LVT-II viscometer at 20 rpm and 20° C., Spindel 3) and is preferably in the range from 150 mPas to 5000 mPas. Preferred compositions have viscosities of from 500 mPas to 4000 mPas, particular preference being given to values of from 1000 mPas to 3500 mPas.

In addition, the inventive liquid washing and cleaning compositions may comprise, in a further preferred embodiment, further ingredients which further improve their performance and/or aesthetic properties. In the context of the present invention, preferred compositions comprise one or more substances from the group of the builders, bleaches, bleach activators, enzymes, electrolytes, pH modifiers, fragrances, perfume carriers, fluorescors, dyes, hydrotropes, foam inhibitors, additional antiredeposition agents or graying inhibitors, optical brighteners, shrinkproofing agents, creaseproofing agents, dye transfer inhibitors, active antimicrobial ingredients, germicides, fungicides, antioxidants, corrosion inhibitors, antistats, ironing aids, repellency and impregnation agents, antiswell and antislip agents, and UV absorbers.

The builders which may be present in the liquid compositions are especially silicates, aluminum silicates (especially zeolites), carbonates, salts of organic di- and polycarboxylic acids, and mixtures of these substances.

Suitable crystalline, sheet-type sodium silicates have the general formula NaMSixO2x+1.yH2O, where M is sodium or hydrogen, x is from 1.9 to 4 and y is from 0 to 20, and preferred values of x are 2, 3 or 4. Preferred crystalline sheet silicates of the formula specified are those in which M is sodium and x assumes the values of 2 or 3. In particular, both β- and δ-sodium disilicates Na2Si2O5.yH2O are preferred.

It is also possible to use amorphous sodium silicates with an Na2O:SiO2 modulus of from 1:2 to 1:3.3, preferably from 1:2 to 1:2.8 and especially from 1:2 to 1:2.6, which have retarded dissolution and secondary wash properties. The retarded dissolution compared to conventional amorphous sodium silicates may have been brought about in various ways, for example by surface treatment, compounding, compaction or by overdrying. In the context of this invention, the term “amorphous” is also understood to mean “x-ray-amorphous”. This means that the silicates, in x-ray diffraction experiments, do not provide sharp x-ray reflections as are typical of crystalline substances, but rather, at best, one or more maxima of the scattered x-radiation which have a width of several degree units of the diffraction angle. However, it can quite possibly lead even to particularly good builder properties when the silicate particles in electron diffraction experiments provide blurred or even sharp diffraction maxima. This should be interpreted such that the products have microcrystalline regions of from 10 to several hundred nm in size, preference being given to values up to a maximum of 50 nm and especially up to a maximum of 20 nm. Such so-called x-ray-amorphous silicates likewise have retarded dissolution compared to the conventional waterglasses. Especially preferred are compacted amorphous silicates, compounded amorphous silicates and overdried x-ray-amorphous silicates.

The finely crystalline zeolite used, which comprises synthetic and bound water, is preferably zeolite A and/or P. Particularly preferred zeolite P is zeolite MAP® (commercial product from Crosfield). However, also suitable are zeolite X and mixtures of A, X and/or P. Commercially available and usable with preference in the context of the present invention is, for example, also a cocrystal of zeolite X and zeolite A (approx. 80% by weight of zeolite X), which is sold by SASOL under the brand name VEGOBOND AX® and can be described by the formula nNa2O.(1-n)K2O.Al2O3.(2-2.5)SiO2.(3.5-5.5).H2O where n=0.90-1.0. The zeolite can be used in the form of a spray-dried powder or else in the form of an undried, stabilized suspension which is still moist from its production. In the case that the zeolite is used in the form of a suspension, it may comprise small additions of nonionic surfactants as stabilizers, for example from 1 to 3% by weight, based on zeolite, of ethoxylated C12-C18 fatty alcohols having from 2 to 5 ethylene oxide groups, C12-C14 fatty alcohols having from 4 to 5 ethylene oxide groups, or ethoxylated isotridecanols. Suitable zeolites have a mean particle size of less than 10 μm (volume distribution; test method: Coulter Counter) and contain preferably from 18 to 22% by weight, especially from 20 to 22% by weight, of bound water.

It is also possible to use the commonly known phosphates as builder substances, provided that such a use should not be avoided for ecological reasons. Especially suitable are the sodium salts of the orthophosphates, of the pyrophosphates and especially of the tripolyphosphates.

Among the compounds which serve as bleaches and supply H2O2 in water, sodium perborate tetrahydrate and sodium perborate monohydrate are of particular significance. Further useful bleaches are, for example, sodium percarbonate, peroxypyrophosphates, citrate perhydrates, and also H2O2-supplying peracidic salts or peracids, such as perbenzoates, peroxophthalates, diperazelaic acid, phthalimino peracid or diperdodecanedioic acid. If present, they are preferably used in enveloped form in order to protect them from decomposition in the course of storage.

In order to achieve improved bleaching in the course of washing at temperatures of 60° C. and lower, bleach activators can be incorporated into the washing and cleaning compositions. The bleach activators used may be compounds which, under perhydrolysis conditions, give rise to aliphatic peroxocarboxylic acids having preferably from 1 to 10 carbon atoms, especially from 2 to 4 carbon atoms, and/or optionally substituted perbenzoic acid. Suitable substances are those which bear O- and/or N-acyl groups of the specified number of carbon atoms and/or optionally substituted benzoyl groups. Preference is given to polyacylated alkylenediamines, especially tetraacetylethylenediamine (TAED), acylated triazine derivatives, especially 1,5-diacetyl-2,4-dioxohexahydro-1,3,5-triazine (DADHT), acylated glycolurils, especially tetraacetylglycoluril (TAGU), N-acylimides, especially N-nonanoylsuccinimide (NOSI), acylated phenolsulfonates, especially n-nonanoyl- or isononanoyloxybenzenesulfonate (n- and iso-NOBS), carboxylic anhydrides, especially phthalic anhydride, acylated polyhydric alcohols, especially triacetin, ethylene glycol diacetate and 2,5-diacetoxy-2,5-dihydrofuran.

In addition to the conventional bleach activators or in their stead, it is also possible to incorporate so-called bleach catalysts into the liquid washing compositions and liquid cleaning compositions. These substances are bleach-boosting transition metal salts or transition metal complexes, for example Mn-, Fe-, Co-, Ru- or Mo-salen complexes or -carbonyl complexes. It is also possible to use Mn, Fe, Co, Ru, Mo, Ti, V and Cu complexes with nitrogen-containing tripod ligands, and also Co-, Fe-, Cu- and Ru-ammine complexes as bleach catalysts.

Useful enzymes for optional use in addition to the calcium-binding enzyme(s) having a calcium binding capacity of at least 1 molar equivalent of calcium per molar equivalent of enzyme for use in accordance with the invention include especially those from the classes of the hydrolases such as the proteases, esterases, lipases or lipolytic enzymes, amylases, cellulases or other glycosyl hydrolases, and mixtures of the enzymes mentioned. In contrast to the enzymes with the specific calcium binding capacity for use in accordance with the invention, these hydrolases for optional additional use contribute in the wash to the removal of stains such as protein-, fat- or starch-containing stains, and graying. Cellulases and other glycosyl hydrolases may additionally, through the removal of pilling and microfibrils, contribute to the color retention and to an increase in the softness of a textile. For bleaching and for preventing dye transfer, it is also possible to use oxidoreductases. Particularly suitable are active enzymatic ingredients obtained from bacterial strains or fungi such as Bacillus subtilis, Bacillus licheniformis, Streptomyceus griseus and Humicola insolens. Preference is given to using proteases of the subtilisin type and especially proteases which are obtained from Bacillus lentus. In this context, enzyme mixtures, for example of protease and amylase or protease and lipase or lipolytic enzymes or protease and cellulose, or of cellulase and lipase or lipolytic enzymes, or of protease, amylase and lipase or lipolytic enzymes, or protease, lipase or lipolytic enzymes and cellulase, but especially protease and/or lipase-containing mixtures or mixtures with lipolytic enzymes, are of particular interest. Examples of such lipolytic enzymes are the known cutinases. Peroxidases or oxidases have also been found to be suitable in some cases. The suitable amylases include especially α-amylases, iso-amylases, pullulanases and pectinases. The cellulases used are preferably cellobiohydrolases, endoglucanases and β-glucosidases, which are also known as cellobiases, or mixtures thereof. Since different cellulase types differ by their CMCase and avicelase activities, the desired activities can be established by means of controlled mixtures of the cellulases.

The bleach activators, bleach catalysts and/or enzymes can be adsorbed on carrier materials and/or enveloped, in order to protect them from premature decomposition. The proportion of these enzymes, enzyme liquid formulations, enzyme mixtures or enzyme granules for use in addition to the calcium-binding enzymes may, for example, be from about 0.1% by weight to 5% by weight, preferably from 0.12% by weight to about 2.5% by weight, based in each case on the overall liquid washing composition or liquid cleaning composition.

The electrolytes used from the group of the inorganic salts may be a wide range of highly varying salts. Preferred cations are the alkali metals and alkaline earth metals; preferred anions are the halides and sulfates. From a production point of view, preference is given to the use of NaCl or MgCl2 in the compositions. The proportion of electrolytes in the compositions is typically not more than 8% by weight, in particular 0.5% by weight to 5% by weight.

In order to bring the pH of the liquid compositions into the desired range, the use of pH modifiers may be appropriate. It is possible here to use all known acids or alkalis, provided that their use is not forbidden for performance or ecological reasons or for reasons of consumer protection. Typically, the amount of these modifiers does not exceed 10% of the overall formulation.

A further optional component, but a component whose presence is desired in a preferential manner in accordance with the invention, in the inventive liquid washing compositions or liquid cleaning compositions is a hydrotrope. Preferred hydrotropes include the sulfonated hydrotropes, for example the alkylarylsulfonates or alkylarylsulfonic acids. Preferred hydrotropes are selected from xylenesulfonate, toluenesulfonate, cumenesulfonate, naphthalenesulfonate or naphthalenesulfonic acid and mixtures thereof. Counterions are preferably selected from sodium, calcium and ammonium. The liquid compositions may optionally comprise up to 20% by weight of a hydrotrope, especially from 0.05% by weight to 10% by weight.

In order to improve the aesthetic impression of liquid compositions, they may be dyed with suitable dyes in a further preferred embodiment. Preferred dyes, whose selection presents no difficulty to the person skilled in the art, possess a high storage stability and insensitivity to the remaining ingredients of the composition and to light, and also no marked substantivity with respect to textile fibers, in order not to stain them.

The foam inhibitors which can be used in the liquid washing and cleaning compositions in a further preferred embodiment include, for example, soaps, paraffins or silicone oils, which may optionally also have been applied to carrier materials.

Suitable antiredeposition agents for use in a further preferred embodiment of the liquid compositions, which are also referred to as “soil repellents”, are, for example, the polymers of phthalic and/or terephthalic acid or derivatives thereof known from the prior art, especially polymers of ethylene terephthalates and/or polyethylene glycol terephthalates or anionically and/or nonionically modified derivatives thereof. Especially preferred among these are the sulfonated derivatives of phthalic acid polymers and terephthalic acid polymers.

In a further preferred embodiment, optical brighteners can be added to the liquid washing and cleaning compositions in order to eliminate yellowing of the treated textile fabrics. These substances attach to the fiber and bring about a brightening by converting ultraviolet radiation which is invisible to the human eye to visible longer-wavelength light, the ultraviolet light absorbed from the sunlight being emitted as pale bluish fluorescence and giving rise to pure white with the yellow shade of yellowed laundry. Suitable compounds stem, for example, from the substance classes of the 4,4′-diamino-2,2′-stilbenedisulfonic acids (flavonic acids), 4,4′-distyrylbiphenyls, methylumbelliferones, coumarins, dihydroquinolinones, 1,3-diarylpyrazolines, naphthalimides, benzoxazole systems, benzisoxazole systems and benzimidazole systems, and also the pyrene derivatives substituted by heterocycles. Optical brighteners are normally used in amounts of up to 0.5% by weight, especially from 0.03% by weight to 0.3% by weight, based on the finished composition.

Since textile fabrics, especially those made of rayon, viscose, cotton and mixtures thereof, can tend to crease because the individual fibers are sensitive toward bending, folding, compressing and crushing transverse to the fiber direction, the inventive compositions may comprise synthetic creaseproofing agents in a preferred embodiment. These include, for example, synthetic products based on fatty acids, fatty acid esters, fatty acid amides, fatty acid alkylol esters, fatty acid alkylolamides or fatty alcohols, which have usually been reacted with ethylene oxide, or products based on lecithin or modified phosphoric esters.

To control microorganisms, the liquid washing and cleaning compositions may comprise active antimicrobial ingredients in a further preferred embodiment. According to the antimicrobial spectrum and mechanism of action, a distinction is drawn here between bacteriostats and bactericides, fungistats and fungicides, etc. Important substances from these groups are, for example, benzalkonium chlorides, alkylarylsulfonates, halophenols and phenylmercuric acetate, but it is also possible to dispense entirely with these compounds in the inventive compositions.

In order to prevent undesired changes to the liquid washing and cleaning compositions and/or the treated textile fabrics caused by the action of oxygen and other oxidative processes, the compositions may, in a further preferred embodiment, comprise antioxidants. This compound class includes, for example, substituted phenols, hydroquinones, pyrocatechols and aromatic amines, and also organic sulfides, polysulfides, dithiocarbamates, phosphites and phosphonates. When such antioxidants are used, the inventive compositions are naturally free of oxidizing bleaches.

Increased wear comfort can result from the additional use of antistats, which are additionally added to the liquid washing and cleaning compositions in a further preferred embodiment. Antistats increase the surface conductivity and hence enable improved dissipation of charges formed. External antistats are generally substances with at least one hydrophilic molecular ligand and impart a more or less hygroscopic film to the surfaces. These usually interface-active antistats can be divided into nitrogen-containing antistats (amines, amides, quaternary ammonium compounds), phosphorus-containing antistats (phosphoric esters) and sulfur-containing antistats (alkylsulfonates, alkyl sulfates). External antistats are, for example, lauryldimethylbenzylammonium chlorides (or stearyldimethylbenzylammonium chlorides), which are suitable as antistats for textile fabrics or as an additive for washing compositions, in which case a softening effect is additionally achieved.

To improve the water absorption capacity, the rewettability of the treated textile fabrics, and to facilitate the ironing of the treated textile fabrics, silicone derivatives, for example, can be used in the liquid washing and cleaning compositions in a further preferred embodiment. These additionally improve the rinseout behavior of the compositions through their foam-inhibiting properties. Preferred silicone derivatives are, for example, polydialkylsiloxanes or alkylarylsiloxanes, in which the alkyl groups have from one to five carbon atoms and are completely or partly fluorinated. Preferred silicones are polydimethylsiloxanes which may optionally be derivatized and are then amino-functional or quaternized, or have Si—OH, Si—H and/or Si—Cl bonds. The viscosities of the preferred silicones at 25° C. are in the range between 100 and 100 000 mPas, the silicones being usable in amounts between 0.2 and 5% by weight, based on the overall composition.

Finally, the liquid washing and cleaning compositions, in a further preferred embodiment, may also comprise UV absorbers which attach to the treated textile fabrics and improve the light stability of the fibers. Compounds which have these desired properties are, for example, the compounds and derivatives of benzophenone with substituents in the 2 and/or 4 position, which are active through radiationless deactivation. Additionally suitable are also substituted benzotriazoles, 3-phenyl-substituted acrylates (cinnamic acid derivatives), salicylates optionally 2-substituted by cyano groups, organic Ni complexes, and natural substances such as umbelliferon and urocanic acid.

The liquid washing compositions and cleaning compositions are preferably clear, i.e. they have no sediment and are transparent or at least translucent. Liquid washing and cleaning compositions without addition of a dye preferably have a transmission of visible light (from 410 to 800 nm) of at least 30%, preferably at least 50% and especially preferably at least 75%.

In addition to the constituents mentioned, a liquid washing and cleaning composition may, though, also comprise particles dispersed therein, whose diameter along its greatest spatial dimension is, for example, from 0.01 μm to 10 000 μm. Such particles may either be microcapsules or speckles, or else granules, compounds and fragrance beads, preference being given to microcapsules or speckles.

The term “microcapsule” is understood to mean aggregates which comprise at least one solid or liquid core surrounded by at least one continuous shell, especially a shell composed of polymer(s). Typically, they are finely dispersed liquid or solid phases enveloped with film-forming polymers, in the course of whose production the polymers are deposited on the material to be enveloped after emulsification and coacervation or interfacial polymerization. The microscopically small capsules can be dried like powder. In addition to single-core microcapsules, multicore aggregates, also known as microspheres, are also known, which comprise two or more cores distributed in the continuous shell material. Single- or multicore microcapsules may additionally be enveloped by an additional second, third, etc shell. Preference is given to single-core microcapsules with a continuous shell. The shell may consist of natural, semisynthetic or synthetic materials. Natural shell materials are, for example, gum Arabic, agar agar, agarose, maltodextrins, alginic acid and salts thereof, e.g. sodium alginate or calcium alginate, fats and fatty acids, cetyl alcohol, collagen, chitosan, lecithins, gelatin, albumin, shellac, polysaccharides such as starch or dextran, sucrose and waxes. Semisynthetic shell materials include chemically modified celluloses, especially cellulose esters and ethers, e.g. cellulose acetate, ethyl cellulose, hydroxypropylcellulose, hydroxypropylmethylcellulose and carboxymethylcellulose, and also starch derivatives, especially starch ethers and esters. Synthetic shell materials are, for example, polymers such as polyacrylates, polyamides, polyvinyl alcohol or polyvinylpyrrolidone.

In the interior of the microcapsules, sensitive, chemically or physically incompatible and volatile components (=active ingredients) of the liquid composition can be enclosed in a storage- and transport-stable manner. The microcapsules may include, for example, optical brighteners, surfactants, complexing agents, bleaches, bleach activators, dyes and fragrances, antioxidants, builders, enzymes, enzyme stabilizers, active antimicrobial ingredients, antiredeposition agents, pH modifiers, electrolytes, foam inhibitors and/or UV absorbers. In addition to the constituents specified above as ingredients of the inventive aqueous liquid compositions, the microcapsules may comprise, for example, vitamins, proteins, preservatives, washing power enhancers or pearlescers. The fillings of the microcapsules may be solids or liquids in the form of solutions or emulsions or suspensions.

Within the scope of production, the microcapsules may have any desired shape, but they are preferably approximately spherical. Their diameter along their longest spatial dimension may, according to the components present in their interior and the application, be between 0.01 μm (visually indiscernible as a capsule) and 10 000 μm. Preference is given to visible microcapsules having a diameter in the range from 100 μm to 7000 μm, especially from 400 μm to 5000 μm. The microcapsules are obtainable by processes known in the prior art, coacervation and interfacial polymerization being of the greatest significance. The microcapsules used may be any surfactant-stable microcapsules supplied on the market, for example the commercial products (the shell material is specified in brackets in each case) Hallcrest Microcapsules (gelatin, gum Arabic), Coletica Thalaspheres (maritime collagen), lipotec millicapsules (alginic acid, agar-agar), induchem unispheres (lactose, microcrystalline cellulose, hydroxypropylmethylcellulose); unicerin C30 (lactose, microcrystalline cellulose, hydroxypropylmethylcellulose), kobo glycospheres (modified starch, fatty acid esters, phospholipids), softspheres (modified agar agar) and kuhs probiol nanospheres (phospholipids).

Alternatively, it is also possible to use particles which do not have a core-shell structure, but rather in which the active ingredient is distributed in a matrix of a matrix-forming material. Such particles are also referred to as “speckles”. A preferred matrix-forming material is alginate. To produce alginate-based speckles, an aqueous alginate solution which also comprises the active ingredient(s) to be enclosed, is dropletized and then hardened in a precipation bath containing Ca2+ ions or Al3+ ions. It may be advantageous for the alginate-based speckles first to be washed with water and then to be washed with a complexing agent in an aqueous solution in order to wash out free Ca2+ ions or free Al3+ ions which can enter into undesired interactions with ingredients of the liquid washing composition and cleaning composition, for example the fatty acid soaps. Subsequently, the alginate-based speckles are washed with water in order to remove excess complexing agents. Alternatively, instead of alginate, it is possible to use other matrix-forming materials. Examples of matrix-forming materials include polyethylene glycol, polyvinylpyrrolidone, polymethacrylate, polylysine, poloxamer, polyvinyl alcohol, polyacrylic acid, polyethylene oxide, polyethoxyoxazoline, albumin, gelatin, acacia, chitosan, cellulose, dextran, Ficoll®, starch, hydroxyethylcellulose, hydroxypropylcellulose, hydroxypropylmethylcellulose, hyaluronic acid, carboxymethylcellulose, deacetylated chitosan, dextran sulfate and derivatives of these materials. The matrix formation proceeds in these materials, for example, via gelation, polyanion-polycation interactions or polyelectrolyte metal ion interactions, and is well known in the prior art, as is the production of particles with these matrix-forming materials. The particles can be dispersed stably in the aqueous liquid washing and cleaning compositions. Stable means that the compositions are stable at room temperature and at 40° C. over a period of at least 4 weeks and preferably of at least 6 weeks, without the compositions frothing or sedimenting.

The active ingredients are released from the microcapsules or speckles typically during the use of the compositions comprising them by destruction of the shell or of the matrix owing to mechanical, thermal, chemical or enzymatic action. In a preferred embodiment of the invention, the liquid washing compositions comprise identical or different particles in amounts of from 0.01 to 10% by weight, especially from 0.2 to 8% by weight and exceptionally preferably from 0.5 to 5% by weight.

The inventive liquid washing and cleaning compositions can be produced inexpensively and simply in customary mixing and filling systems. Preferably, the liquid compositions are produced by initially charging, if present, the acidic components, for example the linear alkylsulfonates, citric acid, boric acid, phosphonic acid, the fatty alcohol ether sulfates, and the nonionic surfactants. The solvent component is preferably also added at this time, but it can also be added at a later time. The complexing agent to be used in accordance with the invention and one or more of the abovementioned calcium-binding enzymes to be used in accordance with the invention are added to these components. Subsequently, a base, for example NaOH, KOH, triethanolamine or monoethanolamine, is added, followed by a fatty acid, if present. Thereafter, the remaining ingredients and, if appropriate, the remaining solvents of the aqueous liquid composition are added to the mixture and the pH is adjusted to the desired value. Finally, if desired, the particles to be dispersed can be added and distributed homogeneously in the aqueous liquid composition by mixing. This is preferably done without supplying thermal energy, more preferably at temperatures in the range from 18 to 23° C.

The present invention also relates, however, to the use of the inventive liquid washing and cleaning compositions in appliances for the cleaning of laundry, fibers, textiles, dishware, glass, and metallic vessels or plastic vessels for the storage of foods or drinks. Suitable appliances are, for example, washing machines or machine dishwashers.

It will be understood that the specification and examples are illustrative but not limitative of the present invention and that other embodiments within the spirit and scope of the invention will suggest themselves to those skilled in the art.

### EXAMPLES

Table 1 reports the composition (ingredients in percent by weight, based in each case on the overall composition) for an inventive liquid washing composition:

TABLE 1

| | |
|---|---|
| C11-C12 LAS | 9.5% |
| C12-C15-alcohol 9 EO ethoxylate | 16% |
| Fatty acid (oleic acid-coconut 6:4) | 9.5% |
| IDS sodium salt | 1-4% |
| Polyaspartic acid sodium salt | 0-3% |
| Citric acid | 0-6% |
| Sodium hydroxide solution | 0-6% |
| Lipex ® 100 L | 0.25% |
| Stainzyme ® 12 L | 0.25% |
| Celluzyme ® 0.7 L | 0.25% |
| Polarzyme ® 12 L | 0.25% |
| pH | 8-9 |
| Water and residual constituents (e.g. salt) | Remainder to 100% |

LAS means linear alkylsulfonate,
EO means ethylene oxide units in a polyglycol or an ethoxylate (reaction product of an alcohol or amine with ethylene oxide)

Table 2 shows four different noninventive liquid formulations stabilized with subtilisin A (subtilisin Carlsberg) without complexing agent for determining the factors crucial for the stability.

TABLE 2

| Composition | A | B | C | D |
|---|---|---|---|---|
| Water in % by weight | 9.0 | 19.1 | 18.8 | 18.8 |
| Formate (mol/kg) | — | — | 0.48 | 0.52 |
| Calcium (% by | 0.01 | 0.059 | 0.068 | 0.1 |
| weight) | | | | |
| Activity AU*/g | 2.81 | 2.93 | 2.78 | 2.85 |
| RA in % after 1 wk. | 89 | 96 | 97 | 99 |
| RA in % after 2 wk. | 87 | 95 | 97 | 98 |
| RA in % after 3 wk. | 79 | 94 | 95 | 97 |
| RA in % after 4 wk. | 76 | 91 | 94 | 95 |
| RA in % after 6 wk. | 67 | 85 | 92 | 93 |
| RA in % after 8 wk. | 64 | 82 | 90 | 94 |
| RA in % after 10 wk. | 61 | 80 | 89 | 93 |

As is evident from Table 2, calcium plays a crucial role; formate can also promote the effect. The formulation D without formate served as the basis for the tests with the corresponding complexing agents (see Table 3).

Table 3 shows, in a continuation from Table 2, the combination of different inventive complexing agents as a substance mixture with a calcium-binding inventive protease, here subtilisin, from which the complexing agents for use in accordance with the invention are notable for their particular stability.

TABLE 3

| Composition | IDS | EDDS | EDTA | MGDA |
|---|---|---|---|---|
| Water in % by wt. | 18.8 | 18.8 | 18.8 | 18.8 |
| Complexing | 1 | 1 | 1 | 1 |
| agent in % by wt. | | | | |
| Calcium in % by wt. | 0.1 | 0.1 | 0.1 | 0.1 |
| Buffer | 0.5 | 0.5 | 0.5 | 0.5 |
| pH | 6.4 | 6.4 | 6.4 | 6.4 |
| Activity, AU*/g | 2.85 | 2.85 | 2.85 | 2.85 |
| RA in % after 1 wk. | 97 | 97 | 70 | 90 |
| RA in % after 2 wk. | 97 | 95 | 49 | 82 |
| RA in % after 3 wk. | 95 | 93 | 37 | 77 |
| RA in % after 4 wk. | 94 | 93 | 30 | 73 |
| RA in % after 6 wk. | 92 | 89 | 18 | 70 |
| RA in % after 8 wk. | 90 | 87 | 10 | 68 |
| RA in % | 86 | 85 | 2 | 65 |
| after 10 wk. | | | | |

In Tables 2 and 3, AU stands for Anson unit, RA for residual activity and wk. for week(s). An Anson unit is defined as that amount of enzyme which, under standardized conditions, degrades urea-denatured haemoglobin, so as to form an amount of TCA-soluble product per minute which, with Folin-Ciocalteu phenol, gives rise to the same color as 1 milliequivalent of tyrosine at 25° C. and pH 7.5 (TCA=trichloroacetic acid).

What is claimed is:

1. A substance mixture comprising a combination of at least one complexing agent having a complex formation constant for calcium of from 3 to 6 with at least one calcium-binding enzyme with a calcium binding capacity of at least 1 molar equivalent of calcium per molar equivalent of enzyme.

2. The substance mixture as claimed in claim 1, wherein the complexing agent used is IDS, EDDS or HEIDA, derivatives thereof and/or salts thereof with alkali metals.

3. The substance mixture as claimed in either of claims 1 and 2, wherein the complexing agent used is IDS, derivatives thereof or salts thereof with alkali metals.

4. The substance mixture as claimed in either of claims 1 and 2, wherein the complexing agent used is HEIDA.

5. The substance mixture as claimed in any one of claims 1 to 4, wherein the calcium-binding enzyme used comprises lipases, cellulases, proteases or alpha-amylases.

6. The substance mixture as claimed in claim 5, wherein lipases from Humicola or Pseudomonas, preferably from Humicola lanuginosa, Humicola insolens, Pseudomonas alcaligenes, Pseudomonas pseudoalcaligens, Pseudomonas cepacia, Pseudomonas stutzeri, Pseudomonas fluorescens, Pseudomonas sp strain SD 705 or Pseudomonas wisconsinensis are used.

7. The substance mixture as claimed in claim 5, wherein the proteases used are alkaline, microbial proteases or trypsin-like proteases, preferably from Bacillus subtilisin Novo, Bacillus subtilisin Carlsberg, Bacillus subtilisin 309, B. subtilisin 147, B. subtilisin 168, Fusarium proteases.

8. The substance mixture as claimed in claim 5, wherein alpha-amylases of Bacillus licheniformis, preferably of variants with substitutions in one or more of positions 15, 23, 105, 106, 124, 128, 133, 154, 156, 181, 188, 190, 197, 202, 208, 209, 243, 264, 304, 305, 391, 408 and 444 are used.

9. The substance mixture as claimed in claim 5, wherein cellulases from Bacillus, Pseudomonas, Humicola, Fusarium, Thielavia, Acremonium, preferably from Humicola insolens, Myceliophthora thermophila, Fusarium oxysporum are used.

10. The method of using the substance mixtures as claimed in claim 1 in liquid washing compositions or liquid cleaning compositions.

11. The method according to claim 10, wherein the liquid washing compositions or liquid cleaning compositions have temperatures of from 10 to 65° C.

12. The method according to claim 10, wherein the aqueous cleaning solutions or wash liquors in which the liquid washing compositions or liquid cleaning compositions are used have a pH of from 6 to 14.

13. A liquid washing composition or liquid cleaning composition, comprising a substance mixture which comprises a combination of a complexing agent having a complex formation constant for calcium of from 3 to 6 with at least one calcium-binding enzyme having a calcium binding capacity of at least 1 molar equivalent of calcium per molar equivalent of enzyme.

14. The method of using the liquid washing composition or liquid cleaning composition as claimed in claim 13 in appliances for the cleaning of laundry, fibers, textiles, dishware, glass and metallic vessels or plastic vessels for the storage of foods or drinks.
